(19) United States
(12) Patent Application Publication
(10) Pub. No.: US 2009/0164051 A1
(43) Pub. Date: Jun. 25, 2009

(54) BLENDED SENSOR SYSTEM AND METHOD

(75) Inventor: Michael J. Vervoordeldonk, Rosmalen (NL)

Correspondence Address: PHILIPS INTELLECTUAL PROPERTY & STANDARDS, P.O. BOX 3001, BRIARCLIFF MANOR, NY, 10510, US

(73) Assignee: KONONKLIJKE PHILIPS ELECTRONICS, N.V., Eindhoven (NL)

(21) Appl. No.: 12/158,401

(22) PCT Filed: Dec. 14, 2006
(86) PCT No.: PCT/IB06/54855

§ 371 Date: Sep. 13, 2008

Related U.S. Application Data
(60) Provisional application No. 60/752,082, filed on Dec. 20, 2005.

(51) Int. Cl. G01B 21/00; G01P 3/00; G05D 3/00

(52) U.S. Cl. 700/302; 702/150; 702/142

(57) ABSTRACT

A blended sensor system and method including a velocity sensor (52) operably connected to monitor velocity of a payload (58) and generate a velocity signal (62); a position sensor (54) operably connected to monitor position of the payload (58) and generate a position signal (64); and a summing node (56) responsive to the velocity signal (62) and the position signal (64) to generate a blended signal (66). The velocity signal (62) dominates the blended signal (66) for high system frequencies, the position signal (64) dominates the blended signal (66) for low system frequencies, and a combination of the velocity signal (62) and the position signal (64) dominates the blended signal (66) for intermediate system frequencies.

This invention relates generally to sensing systems, and more specifically to sensing systems with a blended sensor output.

Certain sensitive manufacturing processes require accurate position sensing instrumentation to determine the position of a component, such as a payload mass relative to a reference mass. One example of a sensitive manufacturing process is photolithography for producing integrated circuits. The photolithography process requires good position measurement to control vibration, which affects the accuracy of the photolithography and reduces the quality of the integrated circuits.

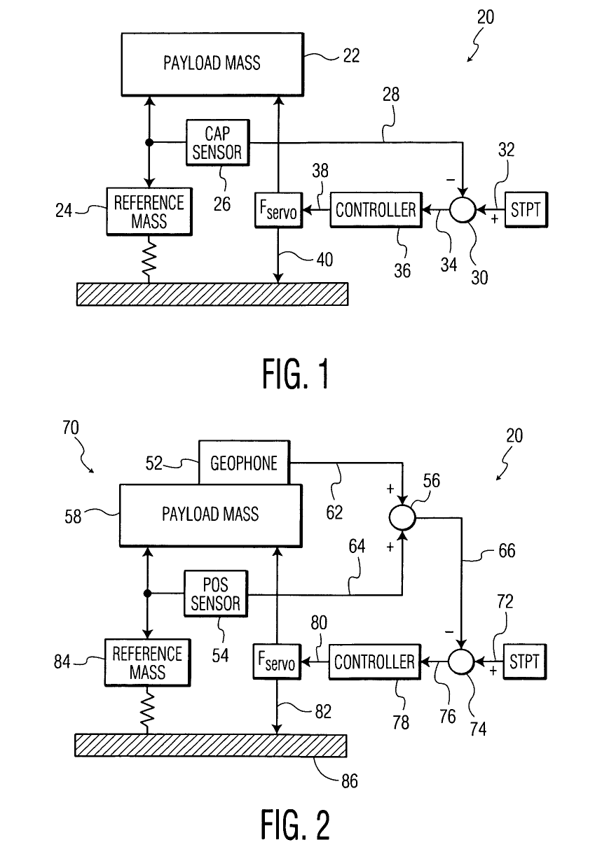

FIG. 1 is a schematic diagram of an active vibration isolation system. The active vibration isolation system is described further in WIPO International Publication No. WO 2005/024266 A1, to Vervoordeldonk, et al., entitled Actuator Arrangement for Active Vibration Isolation Comprising an Inertial Reference Mass, assigned to the assignee of the present application and incorporated herein by reference. The active vibration isolation system 20 measures the position of a payload mass 22 relative to a reference mass 24 using a position sensor 26. The payload mass 22 is supported above ground 44 by passive isolation 42. A position signal 28 from the position sensor 26 is provided to a difference node 30, which compares the position signal 28 to a reference position signal 32 and generates an error signal 34. A controller 36 is responsive to the error signal 34 to generate a control signal 38, which is provided to an actuator 40. The actuator 40 drives the payload mass 22 to actively control vibration of the payload mass 22.

Problems arise from measuring the position of the payload mass 22 relative to the reference mass 24 using the position sensor 26. The position sensor 26 must have a large stroke to account for the range of motion of the payload mass 22 relative to the reference mass 24, but the position sensor 26 cannot be noisy or it will generate vibration in the payload mass 22. For example, one design of an active vibration isolation system requires a stroke of 0.5 millimeters. To maintain noise below 1 nanometer, the signal to noise ratio of the position sensor 26 must be greater than 2×10⁶ [signal to noise ratio=stroke/noise=0.5×10⁻³/1×10⁻⁹=0.5×10⁶]. This corresponds to a signal to noise ratio of about 114 dB, which is difficult if not impossible to achieve at a reasonable cost. Custom capacitive position sensors can be built to meet this requirement, but they are prohibitively expensive. Encoders fail to allow for movement of the payload mass 22 relative to the reference mass 24 in directions other than the direction which is to be measured. Interferometers are also prohibitively expensive.

Low pass filtering of the position signal 28 from the capacitive position sensor 26 suppresses high frequency noise, but low pass filtering is often impossible due to stability and/or performance reasons. The real dynamic behavior of the payload mass 22 is different from the rigid body shown in FIG. 1 and a high sensor bandwidth is essential to create or maintain a stable control loop for actual applications. To establish a stable control loop, the control system must be able to cope with any resonance that shows up in the control loop. Low pass filtering can make this impossible.

It would be desirable to have a blended sensor system and method that overcomes the above disadvantages.

One aspect of the present invention provides a blended sensor system including a velocity sensor operably connected to monitor velocity of a payload and generate a velocity signal; a position sensor operably connected to monitor position of the payload and generate a position signal; and a summing node responsive to the velocity signal and the position signal to generate a blended signal. The velocity signal dominates the blended signal for high system frequencies, the position signal dominates the blended signal 66 for low system frequencies, and a combination of the velocity signal and the position signal dominates the blended signal for intermediate system frequencies.

Another aspect of the present invention provides a method for blending sensors including measuring position of a payload; measuring velocity of the payload; and controlling force to the payload responsive to the position and the velocity.

Another aspect of the present invention provides a blended sensor system including means for measuring position of a payload; means for measuring velocity of the payload; and means for controlling force to the payload responsive to the position and the velocity.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

FIG. 1 is a schematic diagram of an active vibration isolation system;

FIG. 2 is a schematic diagram of an active vibration isolation system including a blended sensor system made in accordance with the present invention;

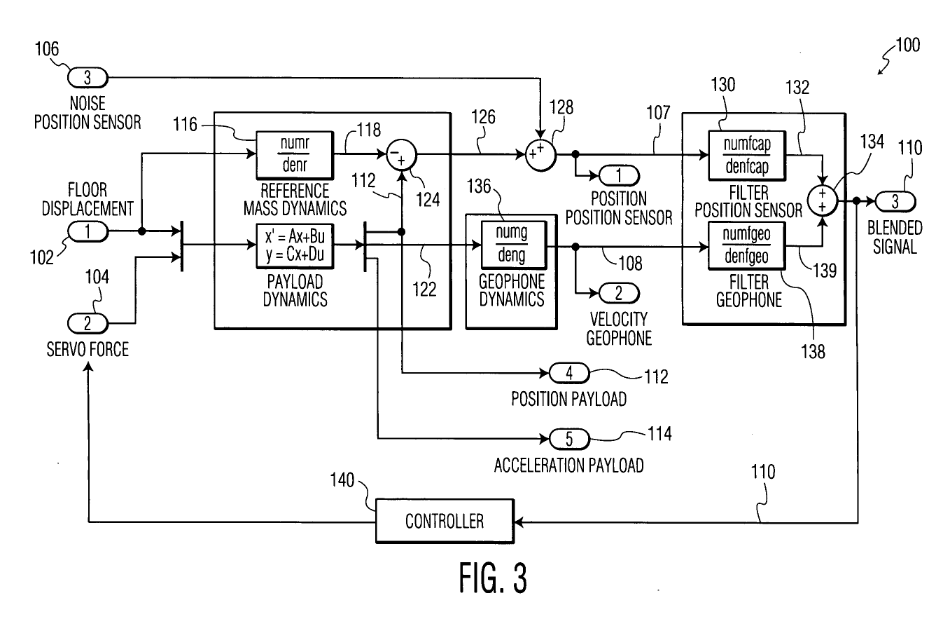

FIG. 3 is a block diagram of a model of an active vibration isolation system including a blended sensor system made in accordance with the present invention;

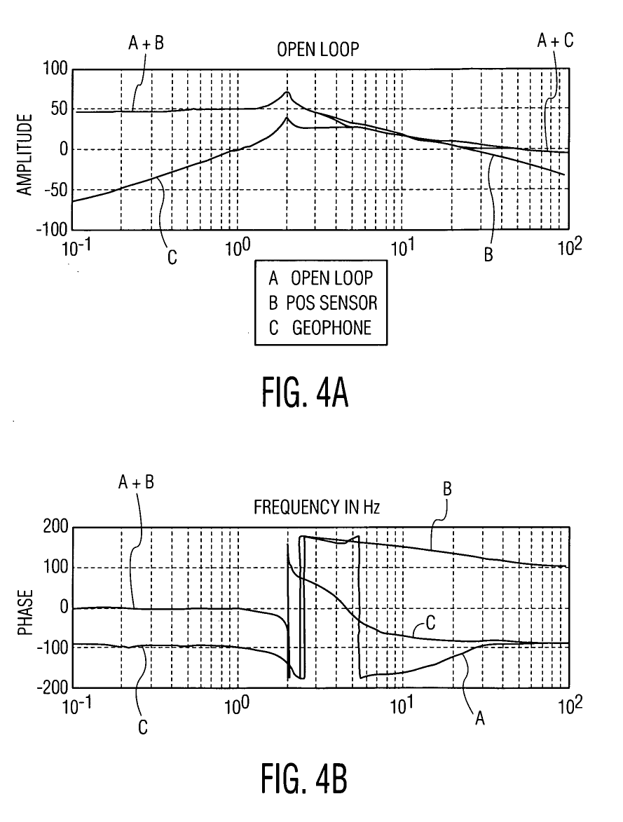

FIGS. 4A & 4B are graphs of amplitude versus frequency and phase versus frequency, respectively, for an active vibration isolation system including a blended sensor system made in accordance with the present invention;

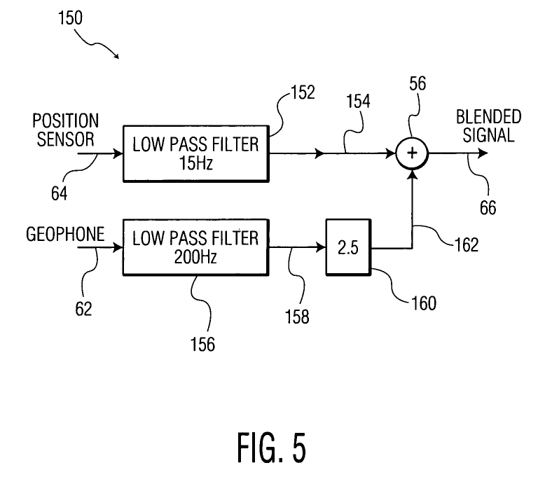

FIG. 5 is a block diagram of another embodiment of a blended sensor system made in accordance with the present invention; and

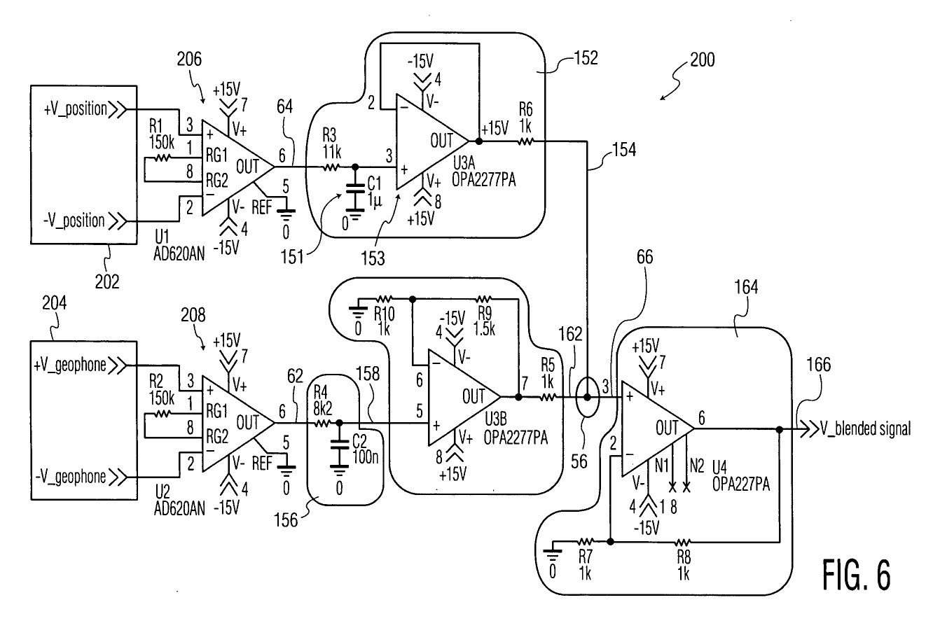

FIG. 6 is a schematic diagram of a blended sensor system circuit made in accordance with the present invention.

FIG. 2 is a schematic diagram of an active vibration isolation system including a blended sensor system made in accordance with the present invention. The blended sensor system 50 includes a velocity sensor 52, a velocity gain 90, a position sensor 54, a position setpoint summing node 94, a position gain 92, and a velocity/position summing node 56. The payload mass 58 is supported above ground 86 by passive isolation 88. The velocity sensor 52 is operably connected to monitor velocity of the payload 58 and generates a velocity signal 62, which is provided to the velocity gain 90. The velocity gain 90 is responsive to the velocity signal 62 to process, i.e., amplify and/or buffer, the velocity signal 62, and generates an adjusted velocity signal 91. The position sensor 54 is operably connected to monitor position of the payload 58 and generates a position signal 64, which is provided to the position setpoint summing node 94. The position setpoint summing node 94 compares the position signal 64 to a reference position signal 72 to generate a position error signal 93. The position error signal 93 is provided to the position gain 92, which generates an adjusted position error signal 95. The position gain 92 processes, i.e., amplifies and/or buffers, the position error signal 93. The summing node 56 is responsive to the adjusted velocity signal 91 and the adjusted position error signal 95 to generate a blended signal 66.

The various signals dominate the blended signal 66 in different frequency ranges, i.e., different signals are the primary contribution to the blended signal 66 in different frequency ranges. The blended signal 66 is primarily the position signal 64 for low system frequencies, the blended signal 66 is primarily the velocity signal 62 for high system frequencies, and the blended signal 66 is a combination of the position signal 64 and the velocity signal 62 for intermediate system frequencies. In one embodiment, the low system frequencies are from about 0 Hz to about 5-10 Hz, the intermediate system frequencies are from about 5-10 Hz to about 20 Hz, and the high system frequencies are above about 20 Hz. Those skilled in the art will appreciate that the transition between the low, intermediate, and high system frequencies can vary with the relative position sensor and velocity sensor contribution selected for a particular application, as well as the system dynamics of the particular application. Those skilled in the art will further appreciate that the way the transition takes place has major impact on the stability of the closed loop, i.e., that the transition must be carefully tailored for the particular application.

The active vibration isolation system 70 employs the blended sensor system 50 to monitor the position and velocity of the payload 58 and provide the blended signal 66. The blended signal 66 passes tuning node 74 to generate a tuned signal 76. The tuned signal 76 is provided to a controller 78, which provides a control signal 80 to actuator 82 to drive the payload 58. The position sensor 54 monitors the position of the payload 58. In one embodiment, the position sensor 54 monitors the position of the payload 58 relative to a reference mass 84, which is softly suspended above a support 86 to minimize vibration of the reference mass 84.

The velocity sensor 52 can be any velocity sensor suitable for monitoring the velocity of the payload 58 and generating a velocity signal 62. In one embodiment, the velocity sensor 52 is a geophone. Geophones typically use a moving coil as a suspended mass in a magnetic field to sense relative velocity between the moving coil and a housing. The coil output voltage is approximately proportional to the relative velocity for frequencies above a resonance frequency. The coil output voltage is the velocity signal 62, indicating velocity of the payload 58 as sensed by the velocity sensor 52. One exemplary geophone is the Model GS-11D available from Geospace Technologies of Houston, Tex. The Model GS-11D has a resonance frequency of about 4.5 Hz. Those skilled in the art will appreciate that a geophone can be used in the non-ideal range below the resonance frequency with the use of a stretch filter, but that such filtering is unnecessary when the geophone is used above the resonance frequency. In another embodiment, the velocity sensor 52 is an accelerometer with an integrated output operably attached to the payload 58 to provide the velocity signal 62.

The position sensor 54 can be any position sensor suitable for monitoring position of the payload 58 and generating a position signal 64. The position sensor 54 is best suited for low and the intermediate system frequencies, such as about 0 to about 5-10 Hz. In one embodiment, the position sensor 54 is a capacitive sensor. Capacitive sensors typically measure distance by monitoring the capacitance between two electrodes, each of the electrodes being operably attached to one of the two components between which the distance is to be measured. For the example of the active vibration isolation system, one electrode is operably attached to the payload 58 and the other electrode is operably attached to the reference mass 84. In one embodiment, the reference mass 84 is one of the electrodes. In another embodiment, the one electrode is operably attached to the payload 58 and the other electrode is operably attached to the support 86. One exemplary capacitive sensor suitable for use as the position sensor is the Model C2-A capacitive sensor probe driven by a Model DMT20 single sensitivity probe driver module available from Lion Precision of St. Paul, Minn. Those skilled in the art will appreciate that the position sensor 54 is not limited to a capacitive sensor and that the position sensor 54 can be any position sensor with suitable noise and stroke for the particular application. For example, the position sensor 54 can be an encoder adapted to allow for the six degrees of freedom of the payload 58, such as an encoder with an intermediate body allowing for tilt and/or horizontal motion of the payload 58.

In operation, the position sensor 54 measures position of the payload 58 relative to the reference mass 84 and the velocity sensor 52 measures velocity of the payload 58. The force to the payload 58 from the actuator 82 is controlled responsive to the position for low system frequencies, responsive to the velocity for high system frequencies, and responsive to a combination of the position and the velocity for intermediate system frequencies. In one embodiment, the low system frequencies are from about 0 to about 5-10 Hz, the intermediate system frequencies are from about 5-10 Hz to about 20 Hz, and the high system frequencies are above about 20 Hz.

The action of the control system as described herein using both a position sensor and a velocity sensor can be explained by comparison with a control system using a position sensor alone as input to a proportional-differential (PD) controller. Using only a position sensor having a position output signal pos, the output u of the PD controller is:

$$u = - ( {k}_{p} \cdot pos + {k}_{d} \frac{d}{d t} ( pos ) ) \qquad ( 1 )$$

Using both a position sensor and a velocity sensor, with the position sensor having a position output signal pos and the velocity sensor having a velocity output signal vel, the output u of the PD controller is:

u=−(kₚ·pos+k_{d}·vel) (2)

Equations (1) and (2) are almost identical, except that the velocity output signal vel is measured directly in Equation (2) rather than being derived from the position output signal pos as in Equation (1). The factors kₚ and kᵥ have different units to make the summation correct with respect to dimensions.

The performance improvement from use of the blended sensor system can be applied as desired in a particular application by relaxing the noise level specification for the position sensor, improving the signal to noise ratio of the active vibration isolation system, increasing the controller bandwidth, or some combination thereof. In one example, an active vibration isolation system having a position sensor with a flat noise spectrum from 0-1 kHz and an allowable payload noise level of 0.1 millimeters/second² one-sigma would require a position sensor with noise less than 2 nanometers one-sigma from 0-1 kHz without the blended sensor system, but a position sensor with noise less than 25 nanometers one-sigma with the blended sensor system. In another example, an active vibration isolation system having a position sensor with a flat noise spectrum from 0-100 Hz and an allowable payload noise level of 0.1 millimeters/second² one-sigma would require a position sensor with noise less than 1.7 nanometers one-sigma from 0-100 Hz without the blended sensor system, but a position sensor with noise less than 5 nanometers one-sigma with the blended sensor system.

FIG. 3 is a block diagram of a model of an active vibration isolation system including a blended sensor system made in accordance with the present invention. The model illustrates the operation of the active vibration isolation system including a blended sensor system. The model 100 includes inputs for floor displacement 102, servo force 104, and capacitive sensor noise 106. The model 100 generates outputs for sensed payload position 107, sensed payload velocity 108, blended signal 110, payload position 112, and payload acceleration 114. The floor displacement 102 is provided to reference mass dynamics block 116, which models the response of the reference mass to generate a reference mass position 118. The floor displacement 102, such as floor vibration, and the servo force 104 are provided to the payload dynamics block 120, which models the response of the payload to generate the payload position 112, the payload acceleration 114, and payload velocity 122. The reference mass position 118 and the payload position 112 are compared at difference node 124 to generate a reference mass/payload position difference 126, which is combined with the capacitive sensor noise 106 at summing node 128 to generate the sensed payload position 107. The capacitive sensor noise 106 models noise from the position sensor. In one embodiment, the sensed payload position 107 is filtered with optional position filter 130 to generate filtered sensed payload position 132, which is provided to summing node 134. In another embodiment, the optional position filter 130 is omitted and the sensed payload position 107 provided to summing node 134.

The payload velocity 122 is provided to geophone dynamics block 136, which models the response of the geophone to generate the sensed payload velocity 108. In one embodiment, the sensed payload velocity 108 is filtered with optional velocity filter 138 to generate filtered sensed payload velocity 139, which is provided to summing node 134. In another embodiment, the optional velocity filter 138 is omitted and the sensed payload velocity 108 provided to summing node 134. The filtered sensed payload position 132 and the filtered sensed payload velocity 139 are combined at the summing node 134 to generate the blended signal 110. The blended signal 110 is provided to controller 140, which generates the servo force 104 acting on the payload.

FIGS. 4A & 4B are graphs of amplitude versus frequency and phase versus frequency, respectively, for an active vibration isolation system including a blended sensor system made in accordance with the present invention, as modeled in FIG. 3. FIGS. 4A & 4B illustrate the contribution of the position sensor and velocity sensor, in this case a geophone, to the blended sensor system as a function of frequency. The open loop results presented in FIGS. 4A & 4B show that the closed loop is stable.

Referring to FIG. 4A, Curve B for the position sensor and Curve C for the geophone are summed to generate Curve A, which is the amplitude portion of the open loop result. Curve B for the position sensor is dominant from below about 5 Hz. Curve C for the geophone is dominant above about 20 Hz. Curve B for the position sensor and Curve C for the geophone contribute equally from about 5 Hz to 20 Hz. In this embodiment, the characteristics of the geophone and the position sensor are such that the contribution of the geophone rolls off for low frequencies and the contribution of the position sensor rolls off for high frequency, so no special filtering is required to force those characteristics. When the characteristics of the geophone and the position sensor are not those desired, filtering of the velocity signal and/or the position signal can be used to optimize the desired dominance as a function of frequency. Those skilled in the art will appreciate that the transition in the intermediate region between low and high frequencies affects stability and performance, so that the transition must be carefully tailored for the particular application. Fine tuning can be used to improve on the performance achieved by static weighting of the position and velocity signals.

FIG. 5, in which like elements share like reference numbers with FIG. 2, is a block diagram of another embodiment of a blended sensor system made in accordance with the present invention. This example of a blended sensor system includes filters and amplifiers as may be required to suit system dynamics and/or to provide fine tuning. The blended sensor system 150 includes a position sensor low pass filter 152, a position amplifier 154, a velocity/position summing node 56, a velocity sensor low pass filter 156, and a velocity amplifier 160. The position sensor low pass filter 152 receives the position signal 64 from the position sensor (not shown) and generates a filtered position signal 153. The filtered position signal 153 is provided to the position amplifier 154, which generates an amplified filtered position signal 155 that is provided to the summing node 56. The position amplifier 154 processes, i.e., amplifies and/or buffers, the filtered position signal 153. The velocity sensor low pass filter 156 receives the velocity signal 62 from the velocity sensor (not shown) and generates a filtered velocity signal 158. The filtered velocity signal 158 is provided to the velocity amplifier 160, which generates an amplified filtered velocity signal 162 that is provided to the summing node 56. The velocity amplifier 160 processes, i.e., amplifies and/or buffers, the filtered velocity signal 158. The summing node 56 combines the amplified filtered position signal 155 and the amplified filtered velocity signal 162 to generate the blended signal 66.

The position sensor low pass filter 152 attenuates noise from the position sensor which can carry over to the blended signal 66. The velocity sensor low pass filter 156 attenuates noise from the velocity sensor which can carry over to the blended signal 66. In one embodiment, the position sensor low pass filter 152 and/or the velocity sensor low pass filter 156 are first order low pass filters with corner frequencies of about 15 and 200 Hz, respectively. The amplifier 160 amplifies the filtered velocity signal 158 to increase the contribution of the velocity sensor to the blended signal 66 relative to the contribution of the position sensor. In one embodiment, the amplifier 160 has a gain of 2.5.

Those skilled in the art will appreciate that additional filters and amplifiers can be added to the blended sensor system 150 to improve performance for a particular application. In one example, a smoothing filter can be added to smooth the transition from position sensor (position signal) dominance to velocity sensor (velocity signal) dominance, i.e., low to intermediate system frequency transitions and intermediate to high system frequency transitions. In another example, various other filters, such as low pass filters, general second order filters, and/or notch filters, can be added to maintain control loop stability. In yet another example, an amplifier can be provided to amplify the blended signal 66.

FIG. 6 is a schematic diagram of a blended sensor system circuit made in accordance with the present invention. The blended sensor system circuit 200 is connected to the position sensor (not shown) at the ±V_position terminals 202 and is connected to the velocity sensor (not shown) at the ±V_velocity terminals 204. A position signal conditioning instrumentation amplifier 206 converts the differential voltage at the ±V_position terminals 202 to the position signal 264, which is provided to the position sensor low pass filter 252. The position sensor low pass filter 252 has a low pass filter circuit 251 including resistor R3 and capacitor C1, and a voltage follower 253 including op amp U3A. The capacitor C1 is connected to common. In this example, the low pass filter circuit has a corner frequency of about 15 Hz. The position sensor low pass filter 252 generates the filtered position signal 254 provided to the velocity/position summing node 356.

A velocity signal conditioning instrumentation amplifier 208 converts the differential voltage at the ±V_velocity terminals 204 to the velocity signal 262, which is provided to the velocity low pass filter 256. The velocity low pass filter 256 has a low pass filter circuit including resistor R4 and capacitor C2, and generates the filtered velocity signal 258. The capacitor C2 is connected to common. In this example, the low pass filter circuit has a corner frequency of about 200 Hz. The velocity amplifier 260 includes op amp U3B with a voltage divider including resistors R9 and R10 setting the amplifier gain. In this example, the amplifier gain is 2.5. The velocity amplifier 260 is responsive to the filtered velocity signal 258 from the velocity sensor low pass filter 256 and generates the amplified filtered velocity signal 362 provided to the velocity/position summing node 356.

The velocity/position summing node 356 generates the blended signal 66 from the filtered position signal 254 and the amplified filtered velocity signal 362. The velocity/position summing node 356 includes resistors R5, R6, R7 and R8 and op amp U4. In this example, the resistor values of resistors R7 and R8 can be used to change the gain of the velocity/position summing node 356. Those skilled in the art will appreciate that the blended sensor system circuit 200 is one example of a blended sensor system circuit and that the particular components and values can be selected as appropriate for a particular application.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof,

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A blended sensor system comprising:
a velocity sensor 52 operably connected to monitor velocity of a payload 58 and generate a velocity signal 62;
a position sensor 54 operably connected to monitor position of the payload 58 and generate a position signal 64; and
a summing node 56 responsive to the velocity signal 62 and the position signal 64 to generate a blended signal 66;
wherein the velocity signal 62 dominates the blended signal 66 for high system frequencies, the position signal 64 dominates the blended signal 66 for low system frequencies, and a combination of the velocity signal 62 and the position signal 64 dominates the blended signal 66 for intermediate system frequencies.

2. The system of claim 1 wherein the intermediate system frequencies are from about 5-10 Hz to about 20 Hz.

3. The system of claim 1 further comprising a reference mass 84, wherein the position of the payload 58 is monitored relative to the reference mass 84.

4. The system of claim 1 further comprising:
a controller 78 responsive to the blended signal 66 to generate a control signal 80; and
an actuator 82 responsive to the control signal 80 and operably connected to drive the payload 58.

5. The system of claim 1 wherein the velocity sensor 52 is selected from the group consisting of a geophone and an accelerometer.

6. The system of claim 1 wherein the position sensor 54 is selected from the group consisting of a capacitive sensor and an encoder with an intermediate body.

7. The system of claim 1 further comprising a position sensor low pass filter 152 operably connected to filter noise from the position signal 64.

8. The system of claim 1 further comprising a velocity sensor low pass filter 156 operably connected to filter noise from the velocity signal 62.

9. The system of claim 1 further comprising a position amplifier 154 operably connected to process the position signal 64.

10. The system of claim 1 further comprising a velocity amplifier 160 operably connected to process the velocity signal 62.

11. The system of claim 1 further comprising a filter operably connected to smooth the frequency transitions selected from the group consisting of low to intermediate system frequency transitions and intermediate to high system frequency transitions.

12. A method for blending sensors comprising:
measuring position of a payload;
measuring velocity of the payload; and
controlling force to the payload responsive to the position and the velocity.

13. The method of claim 12 wherein the controlling comprises controlling force to the payload responsive to the position for low system frequencies, responsive to the velocity for high system frequencies, and responsive to a combination of the position and the velocity for intermediate system frequencies.

14. The method of claim 13 wherein the intermediate system frequencies are from about 5-10 Hz to about 20 Hz.

15. The method of claim 12 wherein the measuring position comprises measuring position relative to a reference mass.

16. The method of claim 12 wherein the measuring position further comprises filtering the position.

17. The method of claim 12 wherein the measuring velocity further comprises filtering the velocity.

18. The method of claim 12 wherein the controlling force to the payload further comprises smoothing the force at transitions selected from the group consisting of low to intermediate system frequency transitions and intermediate to high system frequency transitions.

19. A blended sensor system comprising:
means for measuring position of a payload;
means for measuring velocity of the payload; and
means for controlling force to the payload responsive to the position and the velocity.

20. The system of claim 19 wherein the means for controlling comprises means for controlling force to the payload responsive to the position for low system frequencies, responsive to the velocity for high system frequencies, and responsive to a combination of the position and the velocity for intermediate system frequencies.

21. The system of claim 20 wherein the intermediate system frequencies are from about 5-10 Hz to about 20 Hz.

22. The system of claim 19 wherein the means for measuring position comprises means for measuring position relative to a reference mass.

23. The system of claim 19 wherein the means for measuring position further comprises means for filtering the position.

24. The system of claim 19 wherein the means for measuring velocity further comprises means for filtering the velocity.

25. The system of claim 19 wherein the means for controlling force to the payload further comprises means for smoothing the force at transitions selected from the group consisting of low to intermediate system frequency transitions and intermediate to high system frequency transitions.
